(19) United States
(12) Patent Application Publication
(10) Pub. No.: US 2013/0154402 A1
(43) Pub. Date: Jun. 20, 2013

(54) ACTUATING DRIVE FOR A MOTOR VEHICLE

(71) Applicants: Madhu S. Basavarajappa, Dusseldorf (DE); Nicolas Cavalie, Versailles (FR); Bernardo Erices, Bergisch Galdbach (DE); Frank Kunst, Ludinghausen (DE)

(72) Inventors: Madhu S. Basavarajappa, Dusseldorf (DE); Nicolas Cavalie, Versailles (FR); Bernardo Erices, Bergisch Galdbach (DE); Frank Kunst, Ludinghausen (DE)

(73) Assignee: Kiekert AG

(21) Appl. No.: 13/700,557

(22) PCT Filed: Jan. 19, 2011
(86) PCT No.: PCT/EP2011/050705

§ 371 Date: Mar. 4, 2013

(30) Foreign Application Priority Data
May 28, 2010 (DE) 102010029446.2
Sep. 9, 2010 (DE) 102010040522.1
Sep. 9, 2010 (DE) 202010012379.8

(51) Int. Cl. H02K 5/10; H02K 15/00

(52) U.S. Cl. CPC H02K 5/10; H02K 15/00
USPC 310/20; 29/596

(57) ABSTRACT

The invention relates to an actuating drive for a motor vehicle. It is an object of the invention to provide a further developed actuating drive. It is sought in particular for the actuating drive, in one embodiment, to have a small installation space and/or to be protected against the infiltration of dust and moisture. To achieve the object, the actuating drive comprises a drive, for example an electric motor for a drive wheel with an internal thread. The external thread of a spindle extends into the internal thread. By correspondingly rotating the wheel, an end of the spindle can be moved out of a housing of the actuating drive proceeding from a retracted state. Proceeding from the deployed state, the end of the spindle can be moved in the direction of the housing by correspondingly rotating the wheel in the opposite direction. Furthermore, in one embodiment, the actuating drive comprises an emergency unlocking device.

The invention relates to an actuator for a motor vehicle.

Document DE 102 59 465 A1 discloses an actuator for a fuel filler lid lock of a motor vehicle with an electric motor capable of turning a spindle. A rotary movement of the spindle causes a linear displacement of a locking bar. The locking bar is sealed towards the outside by a bellows in order to protect the actuator against moisture and dirt.

From document DE 196 42 687 A1, an actuator is known with which the connection of a charging plug and a charging socket for charging the battery of an electric motor vehicle is locked.

Document DE 102 14 398 A1 discloses a device which can be used, for example, for locking/unlocking door locks of motor vehicles, the device being equipped with a shape-memory member.

It is the object of the invention to provide an enhanced actuator. In particular, the actuator in one embodiment is supposed have a small construction space and/or be protected against the entry of dust and moisture.

The object of the invention is achieved, in particular, by the actuator having the features of the main claim.

In order to accomplish the object, the actuator comprises a drive unit, for example an electric motor, for a drive gear with an inner thread. The external thread of a spindle reaches into the internal thread. By turning the gear wheel correspondingly, one end of the spindle can be moved out from a housing of the actuator starting from a retracted state. Starting from the extended state, the end of the spindle can be moved in the direction towards the housing by correspondingly turning the gear wheel in the opposite direction.

A drive gear driven by means of an electric motor is also apparent from the documents DE 102 59465 A1 and DE 10 2004 063 814 A1. In contrast to the above-mentioned embodiment, the drive gear already known from these documents is firmly connected to the spindle of the actuator. According to the documents DE 102 59 465 A1 and DE 10 2004 063 814 A1, a component that is independent thereof is used which is provided with an internal thread and a retractable and extendable locking bar. The locking bar corresponds to the above-mentioned end of the spindle that can be extended out of the housing of the actuator. Compared to the present embodiment, an additional construction space has to be made available for the external thread of the independent component known from the documents DE 102 59 465 A1 and DE 10 2004 063 814 A1. Compared to this prior art, construction space can therefore be saved by means of the present invention. Moreover, the proposed drive gear with the external thread and thread spindle has a simpler constructional design compared to the corresponding components known from the documents DE 102 59 465 A1 and DE 10 2004 063 814 A1. Components of a simpler design can be produced with a correspondingly lower production expenditure.

In the case of a motor vehicle, there is a need to be able to lock components, particularly such components that are accessible from the outside. A lid for covering a filler neck that can be closed with a cap in order thus to protect the content of the tank against unauthorized access is an example for such a component. A lock of a connection between a charging socket of an electric vehicle and a charging plug for charging the battery, for the reasons known from document DE 196 42 687 A1, is another example. The above-mentioned end of the spindle that can be extended from the housing, therefore, in one embodiment, serves as a locking bar in order to lock a component with it, for example a fuel filler lid of a motor vehicle or a charging plug that has been plugged into a charging socket of a motor vehicle. This extendable and retractable end of the spindle is therefore also referred to as a locking bar. Examples for such a locking process using a locking bar of an actuator are described in the German patent application DE 10 2010 003 523. We incorporate the solutions and examples for locking components described in the German patent application DE 10 2010 003 523 into the content of the disclosure of the present application. The solutions and examples known therefrom can thus also be embodiments of the present invention.

Such a locking process can be carried out in a convenient manner by means of an electric and/or automated drive unit. For automatic locking, a component, such as a charging socket, for example, comprises a sensor capable of detecting if another component is to be locked, for example a charging plug that has been fully plugged into the charging socket. The sensor then activates the drive unit which then moves the locking bar into its locking position.

However, in the event of a malfunction of the drive unit, for example of the electrical or electronic system for the drive unit, then unlocking is no longer possible by means of the drive unit. For example in the case of a lid covering a filler neck, unlocking is necessary, however, in order to be able to move a vehicle in spite of an electrical or electronic system malfunctioning in this manner. In the case of a locked connection between a charging socket and a charging plug, unlocking also must be possible in a reliable manner, irrespective of malfunctions of the electrical or electronic system, in order to be able to continue to drive the vehicle within a short period of time following a charging process. For this reason, the actuator according to the invention in one embodiment comprises a lever with which the locking bar can be moved, actuated manually, out of its locking position, or extended position, by means of a mechanism. Thus, the actuator comprises an emergency release device that can be actuated manually. Details and embodiments in this regard are apparent from the German patent application DE 10 2010 003 545 and the German patent application DE 10 2010 040 522. We incorporate the pertinent contents of the disclosure of these applications into the content of the disclosure of the present application. The solutions and examples known therefrom can thus also be embodiments of the present invention.

The lever can and should be arranged in such a way that it can be operated only from within the vehicle, either directly or indirectly, for example by means of a Bowden cable, in order to move a locking bar into its non-locking, or retracted, position. Because motor vehicles are, as a matter of principle, designed in such a way that at least one vehicle door and/or lid can also be opened in a purely mechanical way by means of a key, a driver of the motor vehicle can gain access to the interior of his motor vehicle even if an electrical or electronic system provided for locking is malfunctioning. Then, the driver is able to manually actuate the above-mentioned lever of the actuator from the interior in order to move the locking bar back from its extended position. If necessary, a vehicle can then be refueled, or a charging plug can be removed from a charging socket, in order to reliably be able to continue a drive with the vehicle within a short period of time.

In a particularly simple embodiment of the invention, the lever consists of a bolt with a handle mounted thereon or an eyelet mounted thereon for hooking up a Bowden cable. The bolt is guided in a channel of the actuator and can be moved against a stop connected to the locking bar and/or contacts this stop at least when the locking bar is in its extended position. The handle member or the eyelet can be accessed and moved from the outside (i.e. outside the actuator). The handle member can be moved in such a way that the bolt moves the stop, and thus also the locking bar, back into its retracted position.

If a bolt of the locking bar is disposed in a channel, the actuator advantageously comprises a sealing ring which is, in particular, stationarily disposed, and which is capable of sealing a passage between the bolt and the channel. Thus, it is possible to prevent moisture from entering the interior, i.e. an inner space, of the actuator via the channel and from being able to affect the functionality of the electrical and/or electronic system located therein. If the sealing ring is stationarily disposed, the bolt can be displaced relative to the sealing ring.

A channel serving for guidance for the bolt is preferably disposed outside of the inner space in which the spindle and the drive elements for the spindle are located, in order to be able to move a locking bar in accordance with the above-described double stroke. The inner space in this embodiment is formed by a housing in which, therefore, the guide channel for the above-mentioned bolt is not located. The guide channel leads into a bore hole of the housing through which the bolt can be moved into the inner space. This embodiment constitutes an independent invention. We reserve the right to seek independent protection for this independent invention.

If the channel for the bolt is disposed outside of the aforementioned inner space, then a dust-tight and moisture-tight inner space for the spindle and one or more drive elements can be provided particularly simply and reliably.

In one embodiment the actuator comprises a rotatably mounted lever with which the locking bar of the actuator can be mechanically moved mechanically out of its locking position into its non-locking position or initial position by a rotary movement, in the manner known from the German patent application 10 2010 040 522, for the reasons known therefrom. Thus, this actuator comprises an emergency release rotary mechanism that can be actuated manually. The rotatable mounting for the lever, primarily in comparison to a displaceable mounting, can be designed to be tight with a particularly high degree of reliability, without moisture or dust being able to penetrate a corresponding seal or damage such a seal. The rotatable lever is particularly advantageous primarily if the components of the actuating element accommodated within the housing of the actuating element are to be protected against dust and moisture.

In a particularly simple embodiment of the invention, the rotatable lever comprises a rotatable internal lever connected to a rotatable external lever via a rotatably mounted axis in the manner described in the German patent application 10 2010 040 522. The internal lever is situated within the housing of the actuator and therefore cannot be manually actuated. The external lever is situated outside the housing of the actuator and therefore can be manually actuated. The rotatably mounted axis extends through the housing of the actuator. If the external lever is rotated, the rotary movement is transmitted via the axis onto the internal lever. The internal lever is capable of moving the locking bar into its initial position, i.e. into its non-locking position, by means of a corresponding rotary movement. Such an embodiment realizes the desired emergency release in a technically particularly simple and reliable manner.

In one embodiment, the housing of the actuator is sealed in a dust-tight and moisture-tight manner, at least in the fitted state in an overall device.

For example, the overall device is a motor vehicle. In contrast to the prior art known from DE 102 59 465 A1, however, the locking bar is preferably not sealed by a bellows, but by a flat sealing sleeve resting against the housing of the bellows or by an annular seal, which is located in a groove and extends around the locking bar. The required construction space is thus considerably reduced as compared with the prior art known from DE 102 59 465 A1. In the fitted state, the actuator can be pressed with its sealing sleeve against a wall of a component, whereby the connection between the wall of the component and the actuator is sealed in a moisture and dust-tight manner particularly reliably and permanently, particularly also in comparison with the prior art known from DE 102 59 465 A1. Pertinent protection classes relating to moisture and dirt protection can be satisfied without any trouble.

In one embodiment, a stationarily disposed sealing ring is provided through which the locking bar of the actuator extends and relative to which the locking bar can be moved. This stationarily disposed sealing ring is closely adjacent to the locking bar. The stationarily disposed sealing ring is disposed and dimensioned in such a way that it contributes to sealing in a dust-tight and moisture-tight manner the inner space formed by the housing of the actuator from the locking bar. The above-mentioned sealing sleeve is not required in this embodiment. Thus, more construction space can be saved.

In one embodiment, the space of the component, into which the locking bar extends for locking, is or can be sealed in a dust-tight and moisture-tight manner. An example for such a component with a space which can be sealed in a moisture-tight and dust-tight manner, and into which the locking bar of an actuator extends, is evident from the German patent application 10 2010 003 523.8. In particular, such a component is a charging socket for an electric vehicle, which can be suitably sealed in a dust-tight and moisture-tight manner, either by means of a lid or by a charging plug. We incorporate the corresponding content of the disclosure of the German patent application 10 2010 003 523.8 into the present application. On the whole, an overall device with a driving element is thus provided which, compared with the prior art known from DE 102 59 465 A1, has a much smaller construction space and is very well protected against moisture and dirt, especially compared with this prior art. The passage area for the locking bar is particularly susceptible to air and moisture entering the inner space of the actuator. Therefore, two different sealing means are used with particular preference when the locking bar can be moved into a space of another component that can be sealed in a moisture-tight and dust-tight manner. The one sealing means in the form of a sealing ring adjacent to the locking bar permanently ensures a tight connection between the housing of the actuator and the locking bar. The other sealing means, which is provided in the form of a sealing sleeve or a sealing ring, provides for a suitably tight connection between said component and the housing of the actuator in the region of the locking bar. The particularly vulnerable region by the locking bar is thus doubly secured on a corresponding component in the attached state of the actuator, without having to provide a particularly large additional construction space therefor.

In one embodiment of the invention, the actuator comprises a sensor, for example a microswitch, which is capable of detecting the position of the locking bar. To this end, the spindle or the locking bar, if that constitutes a separate component independent from the spindle, can be connected to a ramp which is capable of operating a microswitch when the locking bar is moved out of its locking position, i.e. towards the housing. Conversely, the ramp can also be arranged in such a way that it operates the microswitch when the locking bar is moved into its locking position. The sensor can be connected to a display which is disposed, for example, in the vehicle interior. The driver of a vehicle can thus obtain information as to which position the locking bar of the actuator is assuming. Further details on such a microswitch and its actuation and possibilities for application are described in the German patent application 10 2010 003 545. We incorporate the corresponding content of the disclosure into the present application.

In one embodiment of the invention, a single-walled wall portion of the housing is formed by a membrane consisting of a flexible material which is capable of causing a pressure equalization between the inner space of the housing and the outer region adjacent to the housing. The membrane is part of a single-walled housing wall and not an additional component of the housing wall or part of a double wall. In this respect, the present membrane differs from the bellows known from document DE 102 59 465 A1, which is disposed outside of the housing in addition to a housing wall through which the locking bar of the actuator extends. If, in the case of a dust-tight and moisture-tight housing, the locking bar is moved relative to the housing, then the internal pressure in the dust-tight and liquid-tight housing is changed by such a movement. Temperature changes can lead to pressure differences. Primarily the formation of a negative pressure in the housing would pose a problem because a negative pressure would favor the entry of moisture and dust. The flexible membrane causes a pressure equalization between the pressure inside the housing and the prevailing external pressure. Therefore, it is ensured in an improved manner by means of this embodiment that the inner space remains permanently sealed in a moisture-tight and dust-tight manner. The provision of a dust-tight and moisture-tight housing comprising a flexible membrane as part of a housing wall of an actuator constitutes a separate invention. We reserve the right to seek independent protection for this invention.

In particular, no movable component extends through the above-mentioned membrane. Also in this respect, the membrane differs from the bellows known from document DE 102 59 465 A1. Preferably, the membrane is configured to be wavy, in order to facilitate deformation for the purpose of pressure equalization. One or more wave troughs and/or wave crests extend preferably in an annular manner.

The membrane may consist of an elastomer, for example rubber. In that case, the housing moreover preferably consists of a rigid material, such as, for example, a plastic of little flexibility, for example of polypropylene.

The membrane preferably has a peripherally extending groove which is inserted into an opening portion of the housing wall in order to be capable of being simply and rapidly connected to the adjacent wall of the housing in a suitably tight manner. The edge region of the above-mentioned opening then extends into the groove.

Moreover, the actuator can comprise a biased spring which, due to its bias, is capable of moving the locking bar into a predetermined direction, such as into the locking, i.e. extended, position, for instance. Thus, a supplementary mechanical means is provided in order to be able to move the locking bar into its locking position also in a mechanical way, for example subsequent to a release of a block of the lever of an emergency release device. Thus, the functionality of the actuator can be ensured in a further improved manner.

On the whole, such an actuator can be constructed to be very small. In particular, an actuator according to the invention is a part of a lock for a lid with which a filler neck is covered, or a part of a lock for a charging socket of an electrically driven motor vehicle with a charging plug. If, in one embodiment of the invention, the actuator serves for locking a connection between a charging socket of an electric vehicle and a charging plug, the locking bar, for the purpose of locking, preferably extends into a recess or into a hole in a housing wall of the charging plug in order thus to cause the locking action in a simple and compact manner. Preferably, the actuator is in that case attached from the outside to a housing wall of the charging socket. Furthermore, it is to be preferred that the charging socket and plug are designed in such a way that they are connected by means of a purely translatory movement. Thus, no rotary movement in the manner known from DE 196 42 687 A1 is required for connection. This embodiment of the invention requires a relatively small construction space because no space for any rotary movement in a housing needs to be provided, which simultaneously offers protection against inadvertent touching of the electrical contacts.

The actuator can also comprise several locking bars in the event a component is supposed to be locked particularly securely.

An actuator is preferably produced as follows:
Inserting a first sealing ring into a peripherally extending groove of a first or second housing half, preferably into the first housing half.
Inserting a membrane with a peripherally extending groove into an opening of a first or second housing half, preferably into the first housing half.
Pushing a second sealing ring into a double-walled portion of one of the two housing halves, preferably into the second housing half.
Pushing a spindle with an external thread and an extension arm through the pushed-in second sealing ring in the direction of the extended position. The extension arm can already comprise a ramp shape or additionally comprise a further arm with a ramp shape in order to be able to actuate a microswitch by means of the ramp. If there is another arm, then that includes an angle of preferably 90° with the extension arm in order to extend into another region of the housing. This permits a more flexible arrangement of a microswitch in the housing.
Fitting a drive gear with an internal thread onto one or more bearings of a housing half, preferably onto a bearing of the second housing half.
Screwing the external thread of the spindle into the internal thread of the drive gear, preferably by rotating the drive gear.
Inserting a microswitch into a housing half, preferably into the second housing half. If required, the spindle, before or after the insertion of the microswitch, is rotated in such a way that the arm with the ramp assumes the desired position relative to the microswitch.
Inserting an electric motor into a housing half, preferably into the second housing half.
Pushing a third sealing ring into a double-walled portion of a housing half, preferably of the second housing half.
Pushing a bolt with a handle member attached thereto into a channel through the third sealing ring in the direction towards the inner space of a half shell.
Connecting two half shells by means of screws or rivets.
Inserting a fourth sealing ring around a groove which extends peripherally around the locking bar or spindle and is provided by the two half shells. This fourth sealing ring in that case offers the additional advantage that the two housing halves are additionally pressed together in the critical region by a biased elastic sealing ring.

The insertion according to the process of a membrane with a peripherally extending groove into an opening of a first or second housing half, preferably into the first housing half, is only carried out as an option if such a membrane is provided. Thus, this process step is omitted if no membrane is provided.

A sealing ring within the sense of the method claim can also be inserted by the sealing ring being injected into the peripherally extending groove of a housing half.

In one embodiment, the actuator is attached to a car body member for an electric vehicle which comprises:

a charging socket for charging a battery of an electric vehicle, a first lid for covering the charging socket, a second lid for covering the first lid, the actuator being attached in such a way that the first lid or the second lid can be locked by means of the actuator.

The first lid serves for locking the charging socket in the actual sense, for example in order to seal it from air and moisture. Compared to the second lid, it is therefore preferably considerably smaller, because regions between the lid and the housing of the socket that are to be sealed can thus be minimized. In particular, the base surface area of the first lid is small in comparison with the second lid.

In the closed state, the second lid, together with the car body member, preferably forms a uniform surface, seen from the outside. Such a lid, which, seen from the outside, appears to be a part of the car body and therefore is painted in the same color as the car body as a matter of principle, is known in principle from tank filler necks. Thus, in order to be able to plug a charging plug into the charging socket, the second lid must be opened first, and then the first lid.

In order to prevent unauthorized access, the second lid, in particular, is locked in the closed state by means of the actuator. Because the surface or base surface area of the second lid, which is always visible from the outside, is particularly large, the actuator can preferably be placed in a particularly variable manner. Since there is such a choice, the second lid can generally be locked directly by this first actuator.

In addition to this first actuator, there is, in one embodiment, a second actuator for locking a charging plug plugged into the charging socket. The second actuator can also be directly attached to the housing of the charging socket primarily if the first actuator serves for locking the outer second lid and is therefore disposed with a sufficient distance in space from the charging socket.

It is expedient to dispose the first and/or the second actuator behind the car body member, seen from the second lid. Both actuators are thus protected against direct access. Therefore, a mechanical emergency release device of an actuator cannot be actuated directly. Unauthorized actuations can thus be prevented. As a rule, the actuators are, however, actuated electrically in order to move the respective locking bar into the respectively desired position.

Particularly the first lid and/or the housing of the charging socket is provided with one or more sealing means, particularly with one or more sealing rings, in such a way that the first lid is capable of closing the charging socket in a dust-tight and/or moisture-tight manner. In particular in the case of vehicles, this is particularly important because a vehicle must be capable of withstanding even extreme weather conditions.

The invention is explained in more detail below with reference to exemplary embodiments. Further embodiments and advantages of the invention are illustrated with reference thereto.

### IN THE FIGURES

FIG. 1: shows an actuator from the outside

FIG. 2: shows an actuator from the outside

FIG. 3: shows an actuator from the inside

FIG. 4: shows a section of the membrane

FIG. 5: shows a section in the region of a locking bar

FIG. 6: shows a lever for the emergency release device

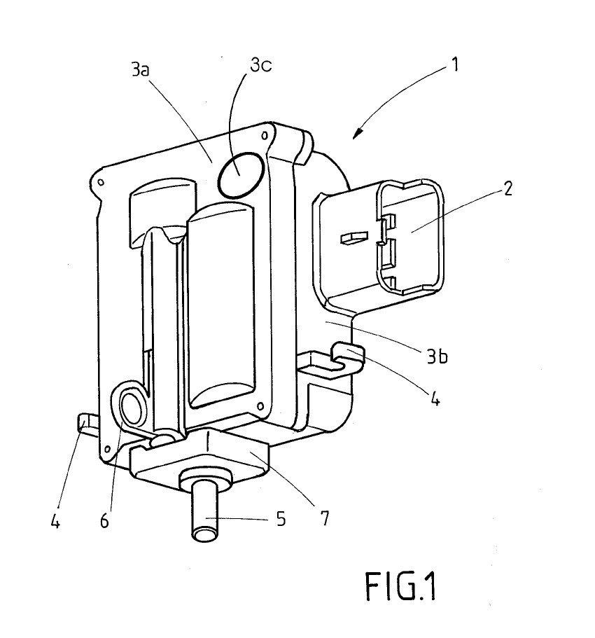

FIG. 1 shows a first example of an actuator 1 with a connection socket 2 via which the actuator can be connected to an electrical power source. The actual drive unit for the locking bar is accommodated within the housing. The housing consists of two half shells 3a and 3b that are connected to each other with four screws. A preferably string-shaped seal consisting, for example, of rubber or another elastic material, is located between the two half shells 3a and 3b in order to connect the two half shells 3a and 3b with each other in a dust-tight and moisture-tight manner. A stretchable membrane 3c is part of the half shell 3a. Moreover, the half shell 3a consists of a relatively rigid plastic material. The half shell 3b also consists of a relatively rigid plastic material. The housing 3a, 3b comprises two projecting tabs 4 which are attached to opposite walls of the housing and are bent in a U-shape. The tabs 4 serve for attaching the actuator 1, for example by means of screws, to another component, such as to a charging socket of a motor vehicle, for example, via which a battery of an electrically driven motor vehicle can be charged. The actuator 1 comprises a locking bar 5 which can be linearly displaced by an electric motor located in the housing 3a, 3b. An eyelet 6 of a lever projects from a lateral wall of the housing 3a, 3b, by means of which the locking bar 5 can be moved mechanically back towards the housing 2, starting from its locking position projecting over the housing 3a, 3b. The eyelet 6 can be easily captured and moved by manual actuation, for example by means of a Bowden cable hooked into the eyelet 6 in a manner suitable therefor.

In one exemplary embodiment, the stroke of the locking bar is at least ten mm in order to be able to lock a desired component, such as a fuel filler lid or a connection between a charging plug and a charging socket, particularly reliably and securely by means of the locking bar.

A sealing sleeve 7, which is pressed tightly against a component to which the actuator is attached, and which is placed on the housing 3a, 3b from the outside, extends around the locking bar 5. The sealing sleeve contributes to dust and moisture being incapable of entering the interior of the actuator, so that pertinent protection classes, particularly also the protection class IP 67, can be satisfied. Due to its flat shape, the sealing sleeve moreover virtually does not increase the required construction space.

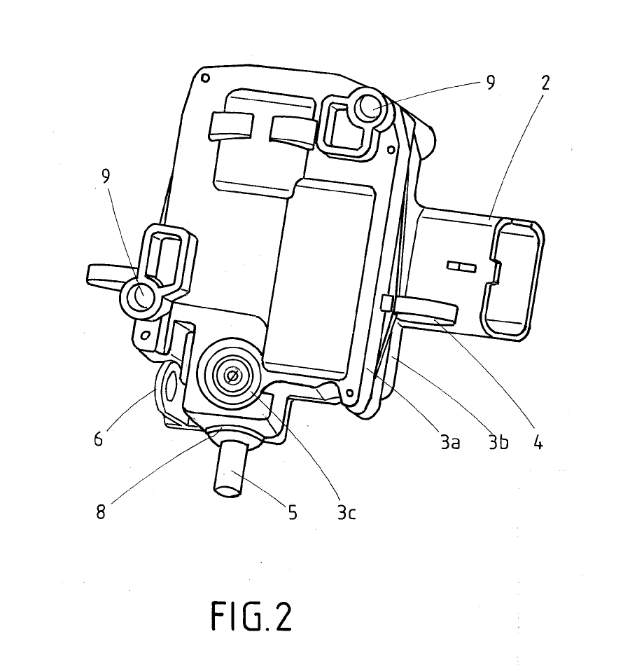

In addition, the actuator depicted in FIG. 1 can be designed in the way described in the German patent application 10 2010 003 545. In that case, the actuator in particular additionally comprises the features of the exemplary embodiment according to the FIGS. 2 to 4, either completely or in combination with individual featured known from the FIGS. 2 to 4.

FIG. 2 shows a second exemplary embodiment of an actuator. Instead of a sealing sleeve, this actuator comprises a stationarily disposed sealing ring 8. The sealing ring 8 is located in a peripherally extending groove provided by the two half shells 3a and 3b of the housing. If the sealing ring is pressed into a suitably dimensioned recess of a component with which the actuator is to be connected, then a corresponding dust-tight and liquid-tight connection is produced between this component and the actuator.

Instead of a simple membrane consisting of a stretchable material, the embodiment shown in FIG. 2 comprises a membrane 3c consisting of a flexible material, with at least one annularly extending wave crest and/or at least one annularly extending wave trough. Even in the case of small pressure differences, the membrane 3c provides for a pressure equalization. The membrane 3c is disposed adjacently to the locking bar 5, whose movements provide for pressure changes within the housing. Because of the proximity, pressure changes can be compensated particularly quickly by the membrane.

Compared to the housing shown in FIG. 1, the housing comprises, for example, two bores 9 which extend perpendicularly to the openings of the tabs 4. The two bores 9 serves as alternative or additional lateral attachment options for the actuator to a component, for example by means of screws.

Another difference of the exemplary embodiment shown in FIG. 2 compared to the exemplary embodiment shown in FIG. 1 lies in the arrangement of the lever with the eyelet 6, which in the case of FIG. 2 is disposed laterally of the locking bar 5, and not, as in the case of FIG. 1, above the locking bar. The spindle associated with the locking bar 5 is then located between the lever with the eyelet 5 and an electric motor for driving the spindle of the actuator. The bolt of the lever with the eyelet 6 is located in a guide channel disposed outside of the inner space provided by the two half shells 3a and 3b.

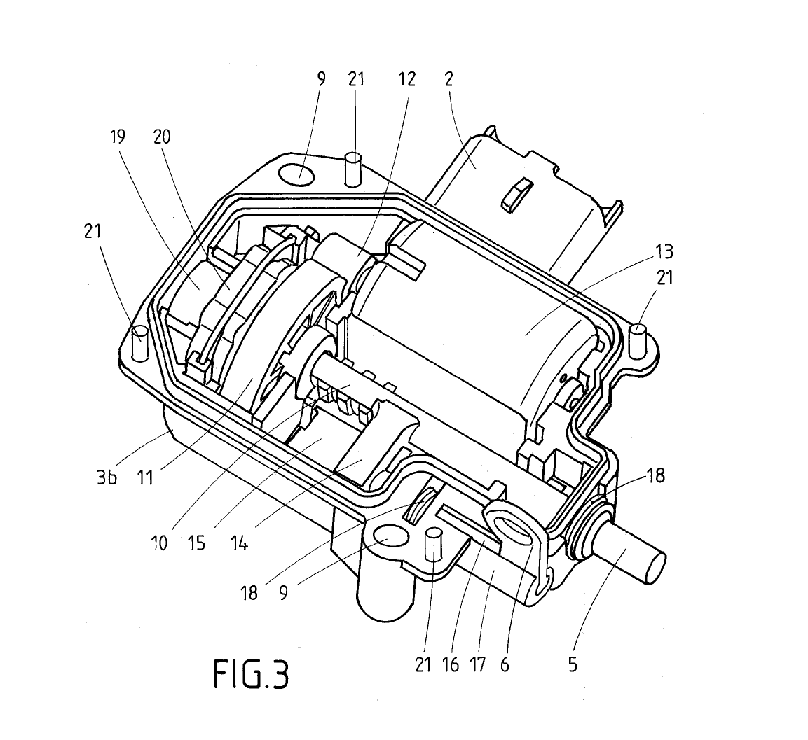

FIG. 3 shows the actuator from FIG. 2 without the half shell 3a, so that the inner space becomes visible. The locking bar 5 is an end portion of the spindle 10. The external thread of the spindle 10 reaches into an internal thread of the drive gear 11. The drive gear 11 rests against a shaft 12 of the electric motor 13. Therefore, the drive gear 11 can be rotated by the shaft 11 by means of the electric motor 13. A perpendicularly projecting extension arm 14, which is able to carry out three functions, is attached to the spindle 10. First, the extension arm can ensure that a rotation of the drive gear 11 does not cause the spindle 10 to be co-rotated unwantedly. It is thus achieved that a rotation of the drive gear 11 causes a translatory movement of the spindle 10, and thus, of the locking bar 5. A translatory movement of the spindle 10 is accompanied by a corresponding translatory displacement. Due to a suitable ramp-shaped design of the lever arm, for example, a key of the microswitch 15 can be actuated. The microswitch 15 is thus able to signal the position the locking bar 5 is in. Moreover, the extension arm 14 can be part of a mechanical emergency release device. The bolt 16, which can be manually pushed into the inner space of the housing by means of the eyelet 6, belongs to such a mechanical emergency release device. By such a movement, the bolt 16 displaces the extension arm 14 correspondingly and thus, the locking bar 5 back into the housing if the locking bar 5 has previously been in its extended position. Because the extension arm 14 is able to take on a total of three functions, this contributes to a particularly compact and simple structure of the actuator. However, in addition to the extension arm 14, for example, a perpendicularly projecting ramp can be attached to the spindle 10, with which the microswitch is actuated. Thus, the extension arm 14 does not mandatorily have to carry out three functions. It already leads to a particularly compact construction space if it is capable to carry out only two of the three above-mentioned possible functions.

The bolt 16 is guided through a channel 17 which is located outside the inner space and in which the spindle 10 is disposed together with the drive and the microswitch 15. At first, the channel 17 leads through a gap into which a sealing ring 18 is inserted so as to tightly adjoin the gap walls. The bolt 18 leads through the sealing ring 18, which at the same time rests tightly against the bolt 16. Finally, the end of the bolt 16 that is capable of moving the extension arm 14 leads into a bore in the half shell 3b which leads into the inner space. This end of the bolt 16 can be pushed through the bore into the inner space in order to be able to correspondingly displace the extension arm 14 and thus the locking bar 5.

The half shell 3b comprises a double wall through which the locking bar 5 can be pushed. A sealing ring 18, which at the same time tightly adjoins the adjacent peripherally extending portion of the locking bar 5, or the adjacent peripherally extending portion of the spindle 10, is inserted so as to tightly adjoin the walls of this double wall. Thus, a permanent dust-tight and liquid-tight connection between the housing and the locking bar 5 or spindle 10 is created with a small requirement of space.

The drive gear comprises a sleeve 19 which is provided with the internal thread of the gear into which the external thread of the spindle 10 reaches.

The longer this sleeve is chosen to be, the longer the stroke or double stroke of the locking bar 10 is. Thus, the sleeve 19 serves for providing a particularly long stroke. Therefore, the length of the sleeve 19 is adapted to the desired stroke length.

The actuator can comprise a spring cassette 20 which is already known from document DE 102 59 465 A1. As described in document DE 102 59 465 A1, the spindle 10 or the locking bar 5 can be automatically re-extended by means of a coil spring if the spindle is retracted and the motor is without power.

In FIG. 3, four screws 21 are outlined with which the two housing halves are connected.

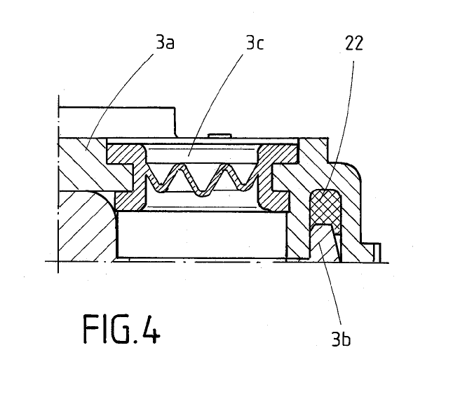

FIG. 4 shows in a cross section a section of the second exemplary embodiment which illustrates the wavy profile of the membrane 3c. Because the membrane 3c consists of a flexible, preferably elastic, material such as rubber, it can be easily inserted into a circular opening of the housing half 3a as illustrated. Moreover, a sealing ring 22 is shown in cross section which provides a moisture-tight and dust-tight connection between the two housing halves 3a and 3b.

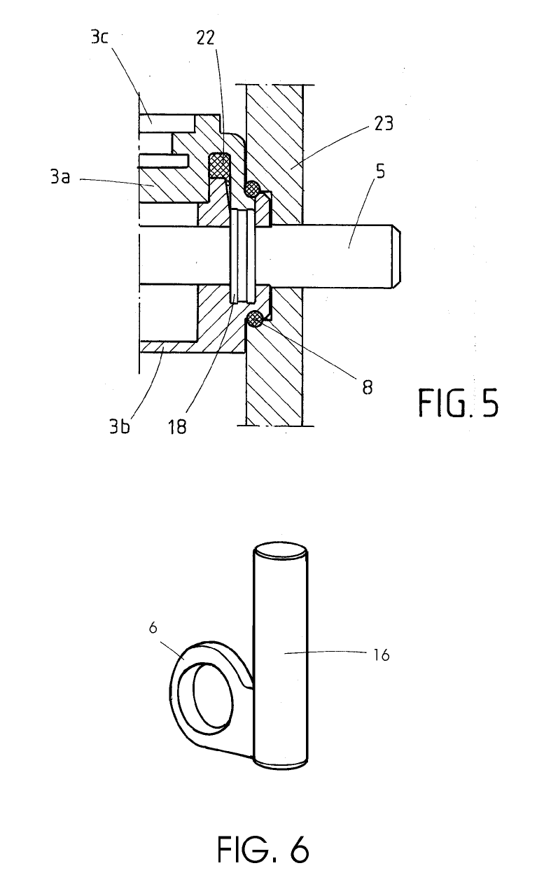

FIG. 5 shows in a cross section a section of the second exemplary embodiment in the region of the locking bar 5 if the actuator is pressed into a recess of a wall 23 of a component as depicted. In that case, the sealing ring 8 provides for a corresponding tight connection between the wall 23 and the actuator in the region of the locking bar 5.

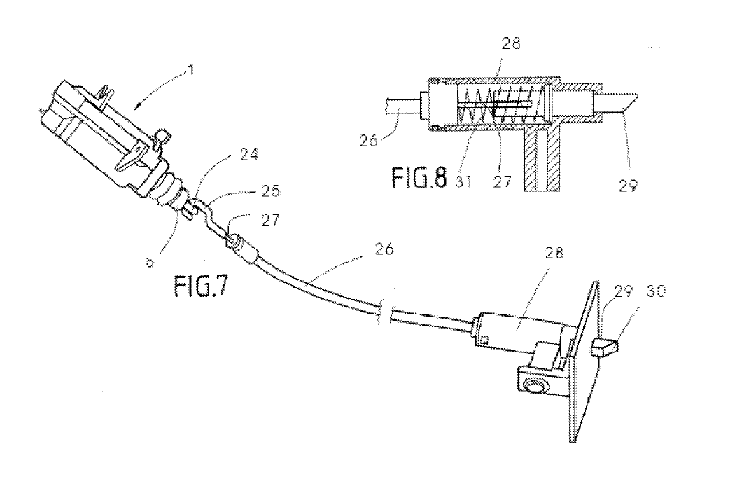

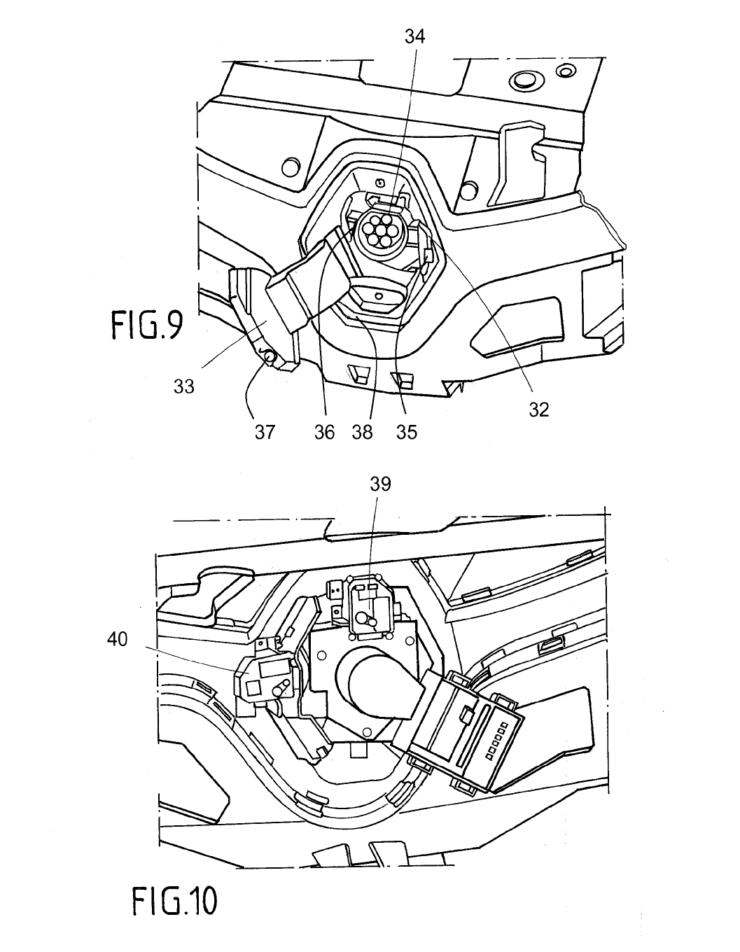

FIG. 6 shows the lever of the emergency release device. It can comprise at the end of the bolt a sealing ring, as shown here and described in the German patent application 10 2010 003 545, for example to prevent the lever of the emergency release device being inadvertently pulled out from the actuator. However, a simple bolt 16 without a sealing ring together with a groove in the bolt 16 provided for retaining such a sealing ring is also sufficient.

FIG. 7 shows an actuator 1 with a locking bar 5 whose end comprises an eyelet 24. A hook 25 of a Bowden cable 26 is hooked into the eyelet 24. The hook 25 is connected to the actual cable 27 of the Bowden cable 26. The other end of the Bowden cable 26 is connected to a locking element 28. The locking element 28 comprises a latching bolt 29. The latching bolt 29 comprises at the end thereof an inclined portion 30 as it is already known from the latching bolt of a lock. If the locking bar 5 is moved from its extended position into the housing, the latching bolt 29 is also moved into the housing of the locking element 28 via the Bowden cable 26. It can thus be unlocked in a remotely actuated manner. Thus, the actuator 1 need not be accommodated in the location in which it is supposed to be locked, e.g. in a fuel filler lid or in a connection between a charging plug and a charging socket. Such an embodiment is advantageous particularly if there is little construction space available at the location of locking.

In particular, the actuator is in this case configured in such a way that the locking bar 5 is moved into the housing of the actuator 1 only electrically. In that case, a spring is provided for outward displacement or extending, which is capable of moving the locking bar 5 into the extended position due to a bias. If the electrical drive unit is deactivated, the locking bar 5 automatically jumps back into the extended position because of the spring. The spring can be a coil spring which turns a spindle, with the rotary movement of the spindle causing the locking bar to move. The consequence of this is that the latching bolt 29 is in that case also located in the extended position. If a lid is closed which is to be locked with the latching bolt 29, the lid, via a corresponding element such as a bolt, first presses the latching bolt back in the direction of the housing because of the inclined portion 30, as this is already known from locks with such latching bolts. If the corresponding element, i.e. for example the bolt, passes the latching bolt 29 in this manner, the latching bolt 29 then snaps back into the extended position behind the element, such as the bolt, whereby the lid is locked. As a matter of principle, the latter can only be opened by moving the latching bolt back in the direction of the housing by means of the actuator. The same applies when a plug is inserted into a charging socket of an electric vehicle. There is also an element in this case which first presses the latching bolt 29 back until the latching bolt 29 has passed the element. If the latching bolt 29 then snaps back, the connection between the charging socket and the charging plug is locked. In normal operation, the actuator is electrically actuated not until unlocking. The consumption of electric power is thus minimized.

FIG. 8 shows a cross section of the structure of the locking element 28. A biased spring 31 which pushes the latching bolt 29 out of the housing of the locking element 28 is situated within the locking element or the corresponding housing. The latching bolt 29 is connected to the cable 27 of the Bowden cable 26.

If the locking bar 5 of the actuator 1 snaps back into the extended position due to a correspondingly biased spring once an electric drive unit is not actuated, then the outer end of the locking bar 5 can also already comprise an inclined portion as described above, i.e. as in the case of a door lock. In this case, the actuator is to be provided directly at the location of the locking action. Locking takes place in the same manner as described above. Electric power is required only for unlocking.

FIG. 9 shows a car body member comprising a first lid 32 and a second lid 33. Both lids are shown in an opened state. A housing 34 of a charging socket can be sealed in a dust-tight and moisture-tight manner by means of the first lid 32. For closing, the first lid 32 comprises a resilient tab 35 which latches into a bolt 36 due to a corresponding inner projection. The bolt 36 is firmly attached to the housing 34. A clamp member 37, which serves for locking the second lid 33 if the opening is closed therewith towards the charging socket, is provided at the edge of the lid 33. If the lid 33 is being closed, a locking bar of an actuator comes into the clamp member 37. In this way, the second lid 33 is held in such a way that it can only be opened if the locking bar is moved back into the housing of the corresponding actuator. The charging socket is then protected against unauthorized access.

The base surface area of the first lid 32 is as small as required for closing the relatively small housing 34. Only the circumferential area of the housing 34 has to be sealed with it in a dust-tight and liquid-tight manner if the inner region of the charging socket with the electrical contacts located therein is to be sealed by the lid 32 in a dust-tight and moisture-tight manner. The base surface area of the second lid 33, which is disposed above it, is considerably larger in comparison. Though the second lid 33 can be pressed also in the closed state against a sealing ring 38 disposed on the car body member in order to protect the inner space closed by the lid 33 against dirt, the point in this case, however, is less to be able to provide a really dust-tight and moisture-tight closed space.

FIG. 9 shows the outer face of the car body member that can be seen from the outside when the car body member is a part of an electric vehicle.

Compared to FIG. 9, FIG. 10 shows an internal view of the car body member. An actuator 39 is attached to an external wall portion of the housing 34 reinforced for stability reasons, so that the associated locking bar can be moved through this reinforced wall portion due to a corresponding opening. If a plug is plugged into the charging socket with the housing 34, there is an opening in the housing of the charging socket through which the locking bar of the actuator 39 can be moved in. In this case, the connection between the charging socket and the charging plug is locked.

Another actuator 40 is attached at right angles relative to the actuator 39, relatively far distant in space, from the outside on the wall area forming the inner space that can be closed by means of the lid 33. The lid 33 can be locked by means of this additional actuator 40.

The present application claims the priority of the German patent application 102010029446 dated 28 May 2010, as well as the priority of the German utility model application 202010012379 dated 9 September 2010.

### LIST OF REFERENCE NUMERALS

1 Actuator

2 Connection socket

3a, 3b Housing/half shell

3c Membrane

4 Tabs

5 Locking bar

6 Lever/handle member

7 Sealing sleeve

8 Sealing ring

9 Bore

10 Spindle

11 Drive gear

12 Shaft

13 Drive unit/Electric motor

14 Extension arm

15 Microswitch

16 Lever

17 Guide channel

18 Sealing ring

19 Sleeve

20 Spring cassette

21 Screws or rivets

22 Sealing ring

23 Wall

24 Eyelet

25 Hook

26 Bowden cable

27 Cable

28 Locking element

29 Latching bolt

30 Inclined portion

31 Spring

32 First lid

33 Second lid

34 Housing

35 Resilient tab

36 Bolt

37 clamp member

38 Sealing ring

39 Actuator

40 Actuator

1. An actuator, comprising
a locking bar that can be retracted and extended by means of a spindle,
an electric drive unit for retracting and extending the locking bar,
a dust-tight and moisture-tight inner space in which the drive unit is located,
with a manually actuatable emergency release device comprising a lever and an extension arm connected with the locking bar, and
a guide channel for the lever disposed outside of the inner space,
the lever comprising a bolt which can be partially pushed through a stationarily disposed sealing ring in order to then arrive in an inner space sealed in a dust-tight and moisture-tight manner,
with a sealing ring, which is disposed in a groove and extends peripherally around the locking bar, for a tight connection between the actuator and the component connected to the actuator,
the sealing ring being inserted into a peripherally extending groove of the housing of the actuator,
with a dust-tight and moisture-tight housing,
a single-walled wall portion of the housing being formed by a membrane consisting of a flexible material,
the membrane being configured in a wavy manner for pressure and/or volume equalization,
with a stationarily disposed sealing ring that extends peripherally around the locking bar and adjoins the locking bar tightly, for a tight connection between the locking bar and the housing,
the actuator being attached to a car body member for an electric vehicle which comprises:
a charging socket for charging a battery of an electric vehicle,
a first lid for covering an opening of the housing of the charging socket, and
a second lid for covering the first lid,
the actuator being attached in such a way that the second lid can be locked by means of the actuator,
the first lid being smaller than the second lid.

2. An actuator comprising a drive unit and a locking bar which can be retracted and extended by means of the drive unit.

3. An actuator according to claim 2, comprising
a locking bar that can be retracted and extended by means of a spindle,
a drive gear with an internal thread,
a drive unit for the drive gear,
an external thread of the spindle which reaches into the internal thread of the drive gear.

4. An actuator according to claim 1, comprising a manually actuatable emergency release device, which in particular comprises a lever and an extension arm connected with the locking bar.

5. An actuator according to claim 1, comprising
a locking bar that can be retracted and extended by means of a spindle,
an electric drive unit for retracting and extending the locking bar,
a dust-tight and moisture-tight inner space in which the drive unit is located,
with a manually actuatable emergency release device comprising a lever and an extension arm connected with the locking bar, and
a guide channel for the lever disposed outside of the inner space.

6. An actuator according to claim 1, comprising an emergency release device comprising a bolt which can be partially pushed through a stationarily disposed sealing ring in order to then arrive in an inner space sealed in a dust-tight and moisture-tight manner.

7. An actuator with a retractable and extendable locking bar according to claim 1, comprising a sealing ring, which is disposed in a groove and extends peripherally around the locking bar, for a tight connection between the actuator and the component connected to the actuator, which is inserted into a peripherally extending groove of the housing of the actuator.

8. An actuator according to claim 7, wherein the groove is formed by two housing halves and the sealing ring is seated biased in the peripherally extending groove.

9. An actuator according to claim 1, comprising a stationarily disposed sealing ring that extends peripherally around the locking bar and adjoins the locking bar tightly, for a tight connection between the locking bar and the housing.

10. An actuator with a retractable and extendable locking bar according to claim 1, comprising a dust-tight and moisture-tight housing, a single-walled wall portion of the housing being formed by a membrane consisting of a flexible material.

11. An actuator according to claim 10, wherein the membrane is configured in a wavy manner for pressure and/or volume equalization.

12. An actuator according to claim 1, attached to a car body member for an electric vehicle comprising: a charging socket for charging a battery of an electric vehicle, a first lid for covering an opening of the housing of the charging socket, and/or a second lid for covering the first lid, the actuator being attached in such a way that the first lid and/or the second lid can be locked by means of the actuator, the first lid preferably being smaller than the second lid.

13. An actuator according to claim 12, comprising a second actuator for locking a charging plug plugged into the charging socket.

14. An actuator according to claim 13, wherein the second actuator is attached on the outside of the housing of the charging socket.

15. An actuator according to claim 13, wherein the first and/or the second actuator is disposed behind the car body member, seen from the second lid.

16. An actuator according to claim 12, wherein the first and/or the second actuator comprises a mechanical emergency release device in addition to an electric drive unit.

17. An actuator according to claim 12, wherein the first lid and/or a housing of the charging socket is provided with sealing means, particularly with sealing rings, in such a way that the first lid is capable of closing the charging socket in a dust-tight and/or moisture-tight manner.

18. Method for producing an actuator according to claim 1, comprising the following steps:
inserting a first sealing ring into a peripherally extending groove of a housing half,
in particular inserting a membrane with a peripherally extending groove into an opening of a housing half,
pushing a second sealing ring into a double-walled portion of a housing half,
pushing a spindle with an external thread and an extension arm through the pushed-in second sealing ring in the direction of the extended position,
fitting a drive gear with an internal thread onto one or more bearings of a housing half, in particular together with a spring cassette,
screwing the external thread of the spindle into the internal thread of the drive gear,
inserting a microswitch into a housing half,
inserting an electric motor into a housing half,
pushing a third sealing ring into a double-walled portion of a housing half,
pushing a bolt with a handle member attached thereto into a channel through the third sealing ring in the direction towards the inner space of a half shell,
connecting two half shells by means of screws or rivets,
inserting a fourth sealing ring around a peripherally extending groove provided by the two half shells.
